(19) United States
(12) Patent Application Publication
(10) Pub. No.: US 2006/0075078 A1
(43) Pub. Date: Apr. 6, 2006

(54) Method for transmitting data, and communication device operating on the basis thereof

(76) Inventor: Klaus Abraham-Fuchs, Erlangen (DE)

Correspondence Address: HARNESS, DICKEY & PIERCE, P.L.C., P.O.BOX 8910, RESTON, VA, 20195, US

(21) Appl. No.: 11/231,884

(22) Filed: Sep. 22, 2005

(30) Foreign Application Priority Data
Sep. 23, 2004 (DE) 10 2004 046 185.6

(51) Int. Cl. G06F 15/177

(52) U.S. Cl. 709/220

(57) ABSTRACT

A method is disclosed for transmitting data to an information indicator. A subset of data is indicated to a human user from a total set of data containing appliance data, the subset of data being ascertained centrally after configuration on the information indicator. In a further disclosed communication device, the information indicator for presenting the appliance data is coupled to a central processor for determining the subset of data from the total set of data containing the appliance data for at least one terminal whose input is connected to the central processor for providing the appliance data.

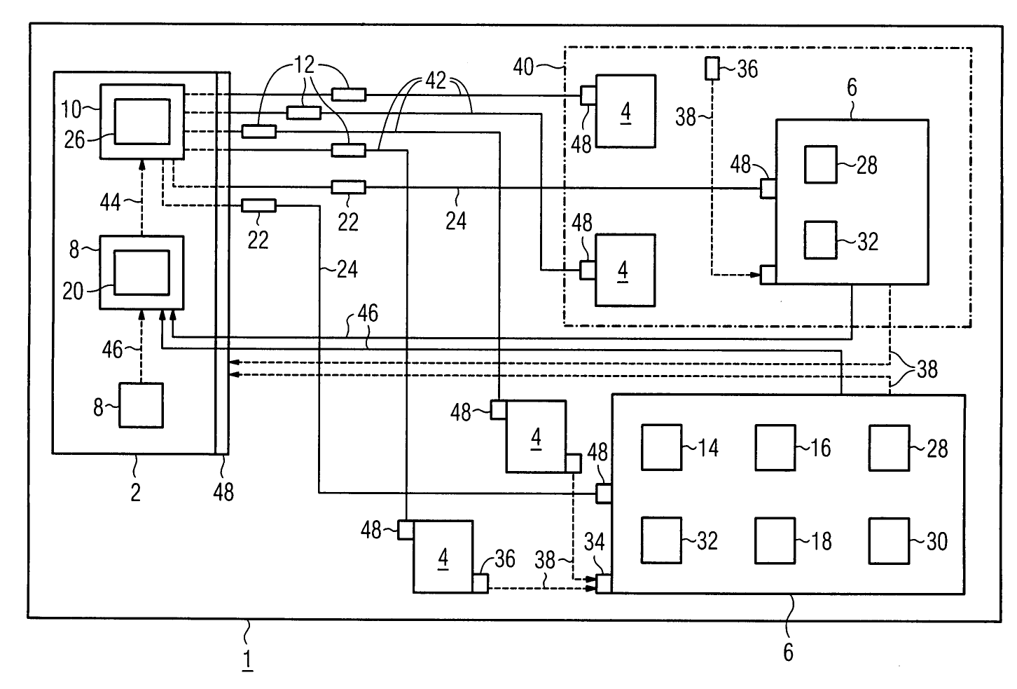

The present application hereby claims priority under 35 U.S.C. §119 on German patent application number DE 10 2004 046 185.6 filed Sep. 23, 2004, the entire contents of which is hereby incorporated herein by reference.

### FIELD

The invention generally relates to a method for transmitting data to an information indicator. It also generally relates to a communication device operating on the basis of this method.

### BACKGROUND

A communication device is used in the field of “smart homes” technology and is used for networking household appliances and entertainment appliances and for remotely controlling them via the network. This requires that a user be provided with information for controlling, operating and maintaining the appliances in question at the correct time and at the correct location and that this information additionally be presented in a clear form.

One way of obtaining such information for the user involves the use of instructions describing the functions of the appliances. It is difficult and therefore undesirable for the user to keep a large number (which is usual in this case) of instructions for a corresponding number of appliances. Since additionally the user firstly does not normally carry around any of the instructions and secondly often knows only comparatively few functions of each appliance, he is often able to use the appliance's functions only to a limited extent in-situ.

### SUMMARY

At least one embodiment of the invention includes an object of specifying a method for obtaining information for appliances found in the household and work environments and a communication device which operates on the basis of the method.

The method of at least one embodiment involves transmitting data to an information indicator in order to indicate a subset of data to a human user from a total set of data containing appliance data, the subset of data being ascertained centrally after configuration of the information indicator. For example, the configuration may take place on the information indicator itself, e.g. using a touchpad, or independently thereof using a mobile telephone (cell phone) or using a separate keypad.

At least one embodiment of the invention may achieve an object via a communication device. The communication device of at least one embodiment may include at least one information indicator for the purpose of presenting appliance data, the information indicator being coupled to a central processor for the purpose of determining the subset of data from the total set of data containing the appliance data for at least one terminal. For the purpose of providing the appliance data, the input of the terminal is connected to the central processor in this case.

In at least one example refinement, the information indicator has an input device provided on it which the user can use to specify an indication profile for the purpose of defining the subset of data. In this context, particular indication options are prescribed on the information indicator and from these the human user can make a selection for the purpose of creating the subset of data. It is also possible for the indication profile to be input and/or for the indication options to be selected by voice control, for example, using an input device in the form of a microphone or by means of direct input using an input device in the form of a keypad. The indication profile created on the information indicator is supplied to the central processor and is stored therein.

In line with one advantageous example refinement, an identification device is provided on the information indicator. This is used to identify the user operating the information indicator. The information indicator supplies the central processor with a signal for activating that indication profile which corresponds to the user identified via the identification device on the information indicator. As a result of the activation of the “user-specific” indication profile, the central processor takes the required appliance date from the total set of data and compiles them into a user-specific subset of data. This subset is supplied to that information indicator at which the user is situated.

In a further expedient example refinement, a device for appliance naming is provided on the information indicator. This is used to assign the information indicator an identification feature, for example an identification number. In the central processor, an information-specific indication profile is activated in line with the identification feature characterizing the information indicator. The central processor uses the information-specific indication profile to create an indicator-specific subset of data containing appliance data and supplies the subset of data to the information indicator.

In accordance with one particular example variant, a time preset device is provided on the information indicator, said time preset device being in the form of a clock, for example. If a plurality of information indicators communicate with the central processor, it is expedient to integrate the time preset device in the central processor—instead of integrating it in the individual information indicators.

This time preset device can be used to indicate subsets of data containing different appliance data on the information indicator at different periods of time. This thus serves to provide the user with different appliance data at particular times in comparison with other times on the information indicator. To this end, a time-interval-specific indication profile is activated in the central processor using the time preset device. The activation is effected by a signal which is output by the time present device when a time period limit is crossed, for example. Using the time-interval-specific indication profile, the central processor creates a time-interval-specific subset of data containing appliance data provided for this purpose and supplies it to the information indicator.

In addition, the communication device may be provided with a device for position finding which allows the position of individual information indicators to be found. To this end, the information indicator can be provided with a reader in the form of a reading and writing unit. The reader communicates with a transponder which is fitted at a suitable location, for example in a space with a plurality of terminals, and/or directly on a terminal. To find the position of the information indicator, the reader supplied with electrical power thereby communicates with the transponder, which may simply be in the form of a passive component.

If the information indicator with the reader is in sufficient range of a transponder, the transponder loosely coupled to the reader transmits a signal about its position to the reader. This signal is expediently forwarded to the central processor via the information indicator. The central processor then assigns that information indicator from which the central processor has obtained the signal to a particular interaction region. The association between the information indicator and the particular interaction region is dependent on the position signal from the transponder which has been assigned to this interaction region in advance. By way of example, the transponders which are in the same space are associated with that interaction region to which the information indicator is assigned when it is in this very space.

Next, a location-specific indication profile which is prescribed for the interaction region is activated in the central processor. Using this indication profile, the central processor again takes appliance data from the total set of data and compiles the appliance data taken into a location-specific subset of data. The location-specific subset of data is supplied to the information indicator in question for the purpose of indicating the appliance data contained therein.

In one example expedient development, a transmission/reception device is provided on the central processor and on the information indicator. The transmission/reception device is used for wireless communication between the central processor and the information indicator. This advantageously also allows the location of the communication device to be moved.

In addition, wireless communication between the central processor and the information indicator also has a particularly cost-saving effect to the extent that no other cables in addition to the cables for the electrical power supply are required for transmitting data. For the purpose of wirelessly transmitting the appliance data from the individual terminals to the central processor and possible data interchange with the central processor in order to control the terminals, the terminals are likewise provided with transmission/reception devices. Accordingly, the communication device can be moved from one location to another regardless of its location and with particular ease.

In line with one advantageous example refinement, the appliance data for the terminals communicating with the central processor are stored in an appliance data store provided in the central processor. This refinement may be used for particularly time-saving compilation of the subset of data from the total set of data stored in the appliance data store using the indication profile.

In addition, it also may be expedient to store the indication profiles in a profile memory provided in the central processor. For particularly time-saving data access, the profile memory may be coupled to the appliance data store.

Advantages obtained with one or more example embodiments of the invention may include, in particular, that the individual indication profiles provided for the communication device for the purpose of compiling the appliance data into individual subsets of data can be configured on the information indicator using the input device. If a plurality of information indicators are provided on the communication device, a user can retrieve a scenario provided for the users with appliance data on any information indicator as a result of the identification device provided. The identification device may refer to a user-specific subset of data being supplied automatically to that information indicator which is being used by the user.

In addition, the time-interval-specific indication profile allows variation between different subsets of data on an information indicator at different periods of time, for example at different times of day.

The appliance data may also be presented on the information indicator visually or else audibly. To this end, the information indicator is provided with a monitor or a loudspeaker, for example. For an indication profile or a plurality of indication profiles to be configured by a user, the information indicator may also be in a form, for example, such that the input device is integrated in the screen as a touchpad and the screen accordingly operates as a touch screen.

In addition, the ability to determine the position of the information indicator provides the opportunity to operate the information indicator at different locations and in the immediate surroundings of different terminals and in so doing always to obtain the appliance data for that terminal which is in the immediate surroundings of the information indicator.

Furthermore, the dual memory system in the central processor with the profile memory and the appliance data store achieves particularly time-saving compilation of the appliance data required for the information indicator.

### BRIEF DESCRIPTION OF THE DRAWINGS

An example embodiment of the invention is explained in more detail below with reference to a drawing, in which the FIGURE shows a block diagram of an example embodiment of an inventive communication device.

### DETAILED DESCRIPTION OF THE EXAMPLE EMBODIMENTS

The communication device 1 of an example embodiment includes a central processor 2, one or more terminals 4 communicating with the central processor 2 and at least one information indicator 6. In addition, the central processor 2 includes two memories, namely a profile memory 8 and an appliance data store 10. The information indicator 6 is preferably in the form of a visual and/or audible indicator.

The communication device 1 presents appliance data 12 for the terminals 4 on the information indicator 6. If the appliance data 12 include information, such as state data or measured data for the terminals 4, this information is presented visually by a monitor 14 on the information indicator 6. If the appliance data 12 are warning or alarm signals, for example, these signals are preferably output audibly via a loudspeaker 16 provided on the information indicator 6.

In addition, the communication device 1 includes, in this example embodiment, an input device 18 which is provided on the information indicator 6 and which a human user can use to specify an indication profile 20. In this context, the indication profile 20 includes details for defining a subset of data 22 containing appliance data 12, the subset being transferred from the central processor 2 to the information indicator 6 for indication.

The indication profile 20 created by the human user is supplied to the central processor 2 via a data link 24 and is stored by the central processor. The human user's input can be made directly by the input device 18, in the form of a keypad for example. Alternatively, the input is made under voice control using an input device 18, in the form of a microphone for example. Expediently, the monitor 14 indicating the appliance data 12 from the subset of data 22 may be provided with a touchpad and is thus in the form of a touchscreen, which may replace an additional input device.

In addition, the input apparatus 18, which may also be in the form of a keyboard provided on the information indicator 6, and/or the touchscreen 14 is used by the human user to input a desired compilation for the subset of data 22 from a total set of data 26. The input by the human user may alternatively be made under voice control using the microphone 16. In contrast to the user-specific or person-specific, previously defined subset of data 22 which is supplied to the information indicator 6 as a result of identification of the human user and which can be regarded as a prescribed scenario for the respective human user, the subset of data 22 compiled on a user-specific basis is based on an input by the human user for the purpose of selecting desired appliance data 12 from the total set of data 26.

To indicate a subset of data 22 from a total set of data 26 containing the appliance data 12 on the information indicator 6 on a time-dependent basis, that is to say to present a time-interval-specific subset of data 22, the central processor 2 includes a time preset device 28 which is expediently in the form of a clock.

To provide the information indicator 6 with a user-specific subset of data 22 defined for a human user in advance, the information indicator 6 has an identification device 30 for identifying the human user. The identification device 30 may be, for example, in the form of a microphone in order to identify the human user through voice recognition. Alternatively, the identification device 30 may be in the form of a touchpad, for example, for the purpose of identifying the human user by means of his fingerprint. As a further alternative for identifying the human user, this can be done by inputting a human-user-specific PIN code using the input apparatus 18 provided on the information indicator 6.

If the communication device 1 includes a plurality of information indicators 6, a device 32 for appliance naming may be expediently provided on each individual information indicator 6, the device defining an identification feature for the respective information indicator 6. This allows an information indicator 6 to be assigned an information-specific subset of data 22 which is provided for it using the identification feature of the respective information indicator 6.

To indicate appliance data 12 from terminals 4 which are in direct proximity to the information indicator 6 on the information indicator 6, the information indicator 6 has a device for finding its position provided on it. The position finding is based on the transformer principle. Accordingly, the device for position finding may include in at least one embodiment, a reader 34 fitted on the information indicator 6 and used as a reading and writing station, and also a transponder 36, used as a transmitter and a responder. The reader 34 communicates with the transponder 36, which is fitted at a suitable location, for example in a space with a plurality of terminals 4, and/or directly on a terminal 4. To find the position of the information indicator 6, the reader 34 supplied with electrical power thereby communicates with the transponder 36, which is in the form of a passive component.

If the information indicator 6 with the reader 34 is in sufficient range of a transponder 36, the transponder 36 loosely coupled to the reader 34 transmits a position signal 38 about its position to the reader 34. The position signal 38 is expediently forwarded to the central processor 2 via the information indicator 6. The central processor 2 then assigns that information indicator 6 from which the central processor 2 has obtained the position signal 38 to a particular interaction region 40. The association between the information indicator 6 and the interaction region 40 is dependent on the position signal 38 from the transponder 36 which has been assigned to this interaction region 40 in advance. By way of example, the transponders 36 which are in the same space are associated with that interaction region 40 to which the information indicator 6 is assigned when it is in this very space.

To compile the subset of data 22 for the information indicator 6, the profile memory 8 in the central processor 2 stores an indication profile 20 which describes the scope and details of the subset of data 22. On the basis of the indication profile 20, the central processor 2 takes the appliance data 12 determined for the subset of data 22 from the total set of data 26 stored in the appliance data store 10. For particularly rapid access to the appliance data 12 in the total set of data 26, the appliance data 12 are stored in those terminals 4 in the appliance data store 10 with which the central processor 2 in the communication device 1 communicates.

Expediently, the appliance data 12 are transmitted from the terminals 4 to the central processor 2 via wireless communication using data signals 42. To take appliance data 12 provided for a subset of data 22 from the appliance data store 10, the latter is coupled to the profile memory 8 via a communication link 44. Using this communication link, the central processor 2 uses the indication profile 20 stored in the profile memory 8 to assign particular appliance data 12 from the appliance data store 10.

If indication profiles 20 created by the human user are stored in the profile memory 8 with subsets of data 22 including appliance data 12, the indication profiles 20 can be activated for the purpose of creating subsets of data 22. The activation is performed using an activation signal 46 which is sent from the information indicator 6 to the central processor 2. This activation signal 46 may firstly be based on position finding for the information indicator 6 and may activate a location-specific indication profile 20 relating thereto. Accordingly, the information indicator 6 is supplied with a subset of data 22 containing appliance data 12 from terminals 4 situated in direct proximity to the information indicator 6 via the data link 24.

Alternatively, the activation signal 46 can be used to activate a user-specific indication profile 20 characterizing a human user. In addition, it is possible to activate a time-interval-specific indication profile 20 on the basis of time, as a result of which the information indicator 6 is provided with appliance data 12 for a period of time defined in advance. It is also possible to activate an information-indicator-specific indication profile 20. This is activated by an identification feature for an information indicator 6, which is created by the appliance naming device 32. Consequently, an information-indicator-specific indication profile 20 characterizing the respective information indicator 6 is retrieved and appliance data 12 which are selected using the information-indicator-specific indication profile 20 are transmitted to the information indicator 6.

To make the communication device 1 flexible and location-independent, the communication between the central processor 2 and the information indicators 6 and also between the central processor 2 and the terminals 4 takes place wirelessly. To this end, a respective transmission/reception device 48 is provided on the information indicator 6 and on the central processor 2 and also on the respective terminal 4.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method, comprising:
transmitting data to an information indicator; and
indicating a subset of data to a human user from a total set of data containing appliance data, the subset of data being ascertained centrally after configuration of the information indicator.

2. The method as claimed in claim 1, wherein the subset of data is defined by creating an indication profile through user-specific input of at least one indication option on the information indicator and supplying the indication profile to the input of a central processor.

3. The method as claimed in claim 1, wherein the subset of data with appliance data presented on the information indicator is defined by activating a prescribed, user-specific indication profile.

4. The method as claimed in claim 1, wherein the subset of data with appliance data presented on the information indicator is defined by activating a prescribed, information-specific indication profile.

5. The method as claimed in claim 1, wherein the subset of data with appliance data presented on the information indicator is defined by activating a time-interval-specific indication profile prescribed for a particular time interval.

6. The method as claimed in claim 1, wherein the information indicator is used to perform position finding on the basis of a transformer principle, and the input of the central processor is supplied with a position signal about the position of the information indicator calculated using the position finding.

7. The method as claimed in claim 6, wherein the information indicator is assigned an interaction region characterizing its position by the central processor.

8. The method as claimed in claim 7, wherein the interaction region is used to activate a prescribed, location-specific indication profile for the purpose of defining the subset of data with appliance data presented on the information indicator.

9. The method as claimed in claim 2, wherein the central processor determines the subset of data from the total set of data on the basis of the respective indication profile and supplies the subset of data to the information indicator.

10. The method as claimed in claim 2, wherein the information indicator communicates wirelessly for the purpose of data interchange with the central processor.

11. The method as claimed in claim 1, wherein the appliance data are stored centrally.

12. The method as claimed in claim 2, wherein appliance data are transmitted to the central processor wirelessly.

13. A communication device comprising:
at least one information indicator for presenting appliance data, coupled to a central processor for determining a subset of data from a total set of data containing the appliance data for at least one terminal whose input is connected to the central processor for providing the appliance data.

14. The communication device as claimed in claim 13, wherein an input device is provided on the information indicator for creating an indication profile.

15. The communication device as claimed in claim 13, wherein an identification device identifying the user of the information indicator is provided on the information indicator for the purpose of activating a prescribed user-specific indication profile.

16. The communication device as claimed in claim 13, wherein a device for appliance naming for creating an identification feature characterizing the information indicator is provided on the information indicator for activating a prescribed information-specific indication profile.

17. The communication device as claimed in claim 13, wherein a time preset device is provided on at least one of the information indicator and the central processor, for activating a prescribed time-interval-specific indication profile for at least one time interval.

18. The communication device as claimed in claim 13, wherein the information indicator has a reader which can be coupled to at least one transponder fitted at at least one of a prescribed location and in a prescribed terminal, for finding the position of the information indicator.

19. The communication device as claimed in claim 18, wherein the information indicator is associated with an interaction region of the transponder for activating a prescribed location-specific indication profile.

20. The communication device as claimed in claim 14, wherein the indication profile activated for determining the subset of data from the total set of data is stored in a profile memory provided in the central processor.

21. The communication device as claimed in claim 13, wherein the appliance data are stored in an appliance data store in the central processor.

22. The communication device as claimed in claim 13, wherein the profile memory is coupled to the appliance data store for compiling the subset of data from the total set of data containing the appliance data.

23. The communication device as claimed in claim 13, wherein a transmission/reception device is provided on the information indicator, on the central processor and on the terminal for wireless data transmission.

24. The method as claimed in claim 2, wherein the subset of data with appliance data presented on the information indicator is defined by activating a prescribed, user-specific indication profile.

25. The method as claimed in claim 2, wherein the subset of data with appliance data presented on the information indicator is defined by activating a prescribed, information-specific indication profile.

26. The method as claimed in claim 2, wherein the subset of data with appliance data presented on the information indicator is defined by activating a time-interval-specific indication profile prescribed for a particular time interval.

27. The method as claimed in claim 2, wherein the information indicator is used to perform position finding on the basis of a transformer principle, and the input of the central processor is supplied with a position signal about the position of the information indicator calculated using the position finding.

28. A method for indicating transmitted data on an information indicator, comprising:
indicating a subset of data to a human user from a total set of data containing appliance data, the subset of data being ascertained centrally after configuration of the information indicator.

29. The method as claimed in claim 28, wherein the subset of data is defined by creating an indication profile through user-specific input of at least one indication option on the information indicator and supplying the indication profile to the input of a central processor.
